(19) United States
(12) Patent Application Publication
(10) Pub. No.: US 2010/0186577 A1
(43) Pub. Date: Jul. 29, 2010

(54) APPARATUS AND METHOD FOR SEARCHING FOR MUSIC BY USING BIOLOGICAL SIGNAL

(75) Inventors: Jae-Pil KIM, Seongnam-si (KR); Sun-Tae Jung, Yongin-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/693,159

(22) Filed: Jan. 25, 2010

(30) Foreign Application Priority Data
Jan. 23, 2009 (KR) 10-2009-0005932

(51) Int. Cl. G10H 7/00

(52) U.S. Cl. 84/612

(57) ABSTRACT

Provided is an apparatus and method for searching for music by using a biological signal. A feature information table is generated which matches sound source feature information about sound sources selected for user situations to biological signal feature information about biological signals measured for the user situations, and similar biological signal feature information to biological signal feature information about a biological signal measured at the request of the user is detected from the feature information table. A sound source having feature information being similar to feature information matched to the detected similar biological signal feature information is searched, thereby enabling automatic selection of a user preferred sound source by using the measured biological signal.

### PRIORITY

This application claims priority under 35 U.S.C. §119(a) to a Korean Patent Application filed in the Korean Intellectual Property Office on Jan. 23, 2009 and assigned Serial No. 10-2009-0005932, the contents of which are incorporated herein by reference.

### BACKGROUND OF THE INVENTION

1. Field of the Invention

The present invention relates generally to a music search apparatus and method, and more particularly, to an apparatus and method for searching for music by using a biological signal such as an ElectroCardioGram (ECG) or a PhotoPlethysmoGraphy (PPG).

2. Description of the Related Art

Users often listen to music while exercising. Based on study results showing that listening to music during exercise has a positive influence on exercise results, a method for searching for music according to a user's heart rate has been developed.

The music search method involves setting a target heart rate for a user, detecting an actual heart rate of the user engaged in exercise, and comparing the detected heart rate with the target heart rate. If the detected heart rate is less than the target heart rate, music having a fast tempo is updated in a current music play list such that the user can exercise while listening to the fast-tempo music.

If the detected heart rate is greater than the target heart rate, music having a slow tempo is updated in the current music play list such that the user can exercise while listening to the slow-tempo music.

In this manner, the music search method compares the current heart rate of the user with the target heart rate and searches for music meeting a user's current condition, such that the found music can be played back by a music player in real time during the user's exercise.

In addition to the aforementioned music search method using the user's heart rate, a music search method using a user's whistle or humming has also been proposed. This music search method uses a change in pitch of the user's humming data being input through a microphone to search for contents in a database which stores sound sources.

As such, conventionally, a heart rate detected from an ECG during exercise is compared with a target heart rate and music having a fast or slow tempo is searched and played depending on the comparison result.

However, conventional music search methods have difficulty in searching for music reflecting a user's preference because these methods use objective value data such as music tempos and sound source data sizes per channel based on the user's heart rate.

Furthermore, the found music may only have a fast or slow tempo, which may be disinteresting the user.

Moreover, when music is searched by using the user's whistle or humming, the accuracy of the search may be negatively impacted depending on the quality of the humming.

### SUMMARY OF THE INVENTION

An aspect of the present invention is to address at least the above problems and/or disadvantages and to provide at least the advantages described below. Accordingly, an aspect of the present invention is to provide an apparatus and method for searching for music by using a biological signal, taking into account user's preference.

According to the present invention, there is provided an apparatus for searching for a sound source, the apparatus including a biological signal measurer for measuring a biological signal of a user, a biological signal feature information extractor for extracting biological signal feature information about the measured biological signal, a sound source feature information extractor for extracting sound source feature information about a sound source, a memory for storing a plurality of sound sources, and a controller for controlling the sound source feature information extractor to extract sound source feature information about a sound source upon user's selection of the sound source, generating a feature information table by matching the biological signal feature information about the measured biological signal to the extracted sound source feature information, controlling the biological signal measurer to measure a biological signal at the request of the user, extracting similar biological signal feature information being similar to that of the measured biological signal from biological signal feature information stored in the feature information table, searching for a sound source having similar sound source feature information to sound source feature information matched to the similar biological signal feature information among the plurality of sound sources stored in the memory, and updating the found sound source in a sound source play list.

According to the present invention, there is provided a method for searching for a sound source, the method including extracting sound source feature information about a sound source if the sound source is selected by a user, measuring a biological signal of the user for each situation of the user, extracting biological signal feature information about the measured biological signal, generating a feature information table by matching the extracted biological signal feature information to the extracted sound source feature information, measuring a biological signal at the request of the user, detecting similar biological signal feature information to the extracted biological signal feature information from biological signal feature information stored in the feature information table, searching for a sound source having similar sound source feature information to sound source feature information mapped to the detected similar biological signal feature information from among a plurality of sound sources, and updating the found sound source in a sound source play list.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 illustrates an apparatus for searching for music according to an embodiment of the present invention;

FIG. 2 illustrates a feature information table according to an embodiment of the present invention;

FIG. 3 illustrates a process of generating the feature information table by the music search apparatus according to an embodiment of the present invention; and

FIG. 4 illustrates a process of searching for a user preferred sound source by using the feature information table by the music search apparatus according to an embodiment of the present invention.

### DETAILED DESCRIPTION OF EMBODIMENTS OF THE INVENTION

Hereinafter, embodiments of the present invention will be described in detail with reference to the accompanying drawings. Detailed descriptions of well-known functions and constructions are omitted for the sake of clarity and conciseness.

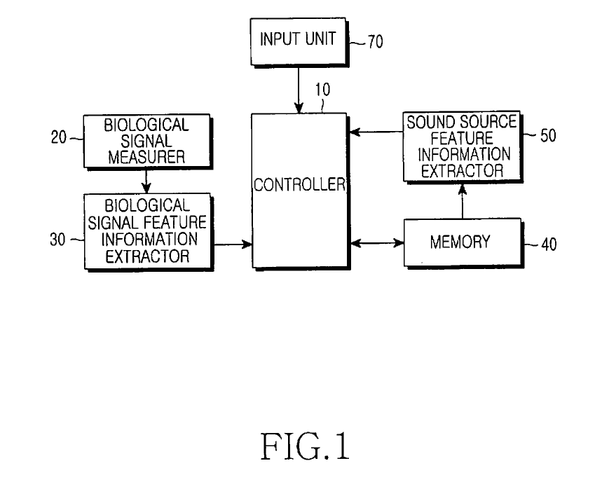

FIG. 1 illustrates an apparatus for searching for music according to an embodiment of the present invention.

Referring to FIG. 1, the music search apparatus includes a controller 10, a biological signal measurer 20, a biological signal feature information extractor 30, a memory 40, a sound source feature information extractor 50, and an input unit 70.

The controller 10 controls an overall operation of the music search apparatus, and particularly, determines whether a category input has been made by a user through the input unit 70. A user situation-based category indicates a user situation such as exercise, rest, or fatigue.

The controller 10 inputs therein the user's selection of a sound source preferred by the user for each category through the input unit 70.

The controller 10 generates music selection lists of sound sources selected by the user for respective user situation-based categories. That is, the generated music selection lists may include a music selection list of sound sources which the user desires to listen to when exercising, a music selection list of sound sources which the user desires to listen to when resting, and a music selection list of sound sources which the user desires to listen to when fatiguing.

The controller 10 controls the sound source feature information extractor 50 to extract sound source feature information about each of sound sources included in the generated music selection list. The sound source feature information may include information such as a title, a singer, a pitch change, a tempo, and a duration of a sound from a sound source.

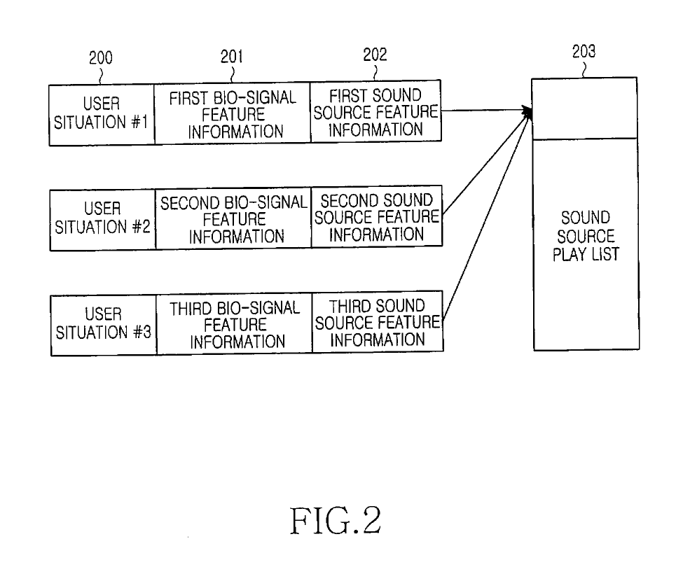

The controller 10 maps the extracted sound source feature information to the corresponding user situation-based category and stores mapping data therebetween in the memory 40. Specifically, referring to FIG. 2, the controller 10 maps a user situation #1 200 being input through the input unit 70 to extracted first sound source feature information 202 and stores mapping data there between.

Thereafter, if a biological signal measurement request is input through the input unit 70, the controller 10 controls the biological signal measurer 20 to measure a biological signal, or bio-signal, such as the ECG or PPG of the user, and controls the biological signal feature information extractor 30 to extract bio-signal feature information about the measured bio-signal. The bio-signal feature information includes information about maximum, minimum, mean, and standard deviations of the heart rate, and Heart Rate Variability (HRV). The user measures the bio-signal while listening to selected music.

The controller 10 generates a feature information table which matches the first bio-signal feature information 201 extracted by the biological signal feature information extractor 30 to the first sound source feature information 202 mapped to the user situation #1 200, as shown in FIG. 2.

If a sound source update request is input through the input unit 70, the controller 10 controls the biological signal measurer 20 to measure a bio-signal of the user, and controls the biological signal feature information extractor 30 to extract bio-signal feature information.

The controller 10 compares bio-signal feature information stored in the feature information table with the extracted bio-signal feature information to detect similar bio-signal feature information to the extracted bio-signal feature information from the feature information table. The controller 10 determines that bio-signal feature information stored in the feature information table is similar to the extracted bio-signal feature information if a difference therebetween is less than a threshold.

The controller 10 extracts sound source feature information matched to the detected similar bio-signal feature information and compares the extracted sound source feature information with sound source feature information about sound sources stored in the memory 40.

The controller 10 detects a sound source having similar sound source feature information to the extracted sound source feature information from the memory 40. The controller 10 determines that sound source feature information about a sound source stored in the memory unit 40 is similar to the extracted sound source feature information if a difference therebetween is less than a threshold.

Thereafter, the controller 10 updates the detected sound sources in the sound source play list 203. The present invention may extract a sound source having similar sound source feature information to sound source feature information stored for each user situation-based category and generate a sound source update list during generation of the feature information table, instead of updating the sound source play list 203 on a real time basis.

In this regard, in the present invention, a sound source being similar to a user preferred sound source can be searched and provided based on a user situation.

The biological signal measurer 20 measures a bio-signal such as an ECG or a PPG and delivers the same to the biological signal feature information extractor 30. More specifically, the biological signal measurer 20 measures the bio-signal such as the ECG or the PPG and extracts heart rate information based on peak information about respective bits of the measured bio-signal, after which it extracts an HRV by using the extracted heart rate information.

The biological signal feature information extractor 30 extracts bio-signal feature information about the received bio-signal. More specifically, the biological signal feature information extractor 30 may extract feature information associated with a heart rate, resulting from wavelet transform on respective bits of the bio-signal, and using frequency characteristic values of the HRV. The biological signal feature information extractor 30 may extract, as the bio-signal feature information, a power spectrum value, which is an integral of a Power Spectrum Density (PSD) between a low-frequency band and a high-frequency band determined from a frequency component acquired by Fast Fourier Transform (FFT) with respect to maximum, minimum, mean, and standard deviations of the heart rate, and the HRV.

The memory 40 stores a plurality of sound sources, a sound source play list, a sound source update list, and a feature information table.

The sound source feature information extractor 50 extracts sound source feature information about a sound source selected through the input unit 70. The extracted sound source feature information may include information such as a pitch change, a duration of a sound source, and a tempo used by a sound source.

The input unit 70 inputs therein a user situation-based category from the user according to a sound source search request, and also a selection of a sound source for the input user situation-based category. The input unit 70 further inputs therein a sound source update request.

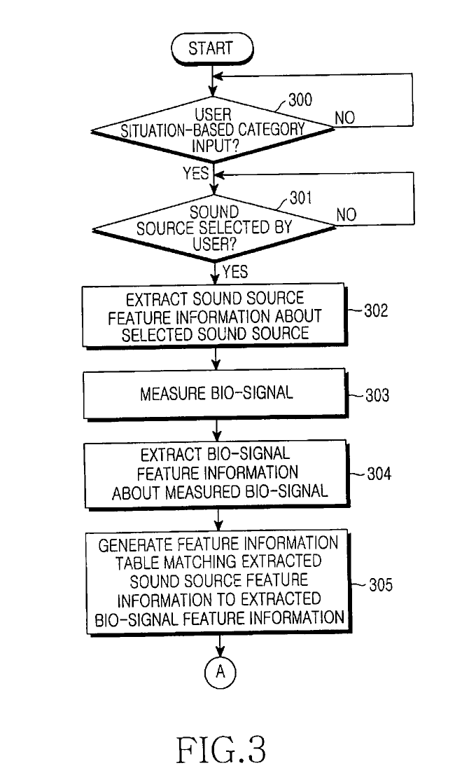

FIG. 3 illustrates a process of generating the feature information table by the music search apparatus according to an embodiment of the present invention.

Referring to FIG. 3, the controller 10 proceeds to step 301 if a user situation-based category is input from the user through the input unit 70 in step 300. Otherwise, the controller 10 continuously determines whether a user situation-based category is input through the input unit 70 in step 300. The user situation-based category indicates a user situation such as exercise, rest, or fatigue.

The controller 10 determines whether a user preferred sound source is input, or selected, from a user for each user situation-based category through the input unit 70 in step 301. If so, the controller 10 proceeds to step 302. Otherwise, the controller 10 continuously determines whether a user preferred sound source is input in step 301.

In step 302, the controller 10 controls the sound source feature information extractor 50 to extract sound source feature information about the selected user preferred sound source, and maps the extracted sound source feature information to the input user situation-based category and stores mapping data therebetween.

In step 303, the controller 10 controls the biological signal measurer 20 to measure a bio-signal.

In step 304, the controller 10 controls the biological signal feature information extractor 30 to extract bio-signal feature information about the measured bio-signal.

In step 305, the controller 10 generates a feature information table matching the extracted bio-signal feature information to the sound source feature information and stores the feature information table in the memory 40.

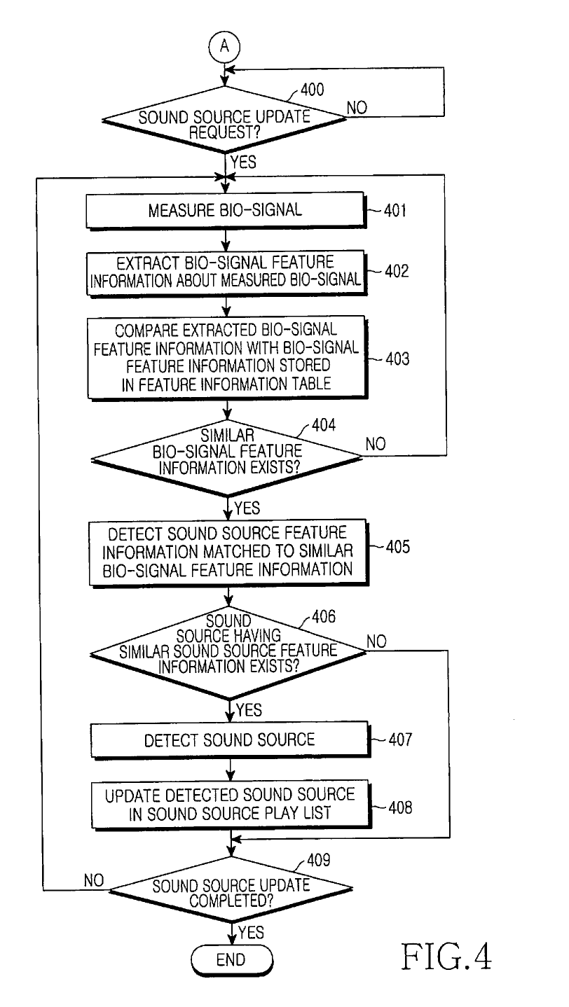

After step 305, the process proceeds to (A) which, together with subsequent steps thereof, will be shown in FIG. 4. With reference to FIG. 4, a detailed description will be made of a process of searching for the user preferred sound source by using the feature information table. Herein, (A) of FIG. 4 continues from (A) of FIG. 3.

FIG. 4 illustrates the process of searching for the user preferred sound source by using the feature information table by the music search apparatus according to an embodiment of the present invention.

The controller 10 determines whether a sound source update request is input from the user through the input unit 70 in step 400. If so, the controller 10 proceeds to step 401. Otherwise, the controller 10 continuously determines whether the sound source update request is input in step 400.

In step 401, the controller 10 controls the biological signal measurer 20 to measure a bio-signal of the user.

In step 402, the controller 10 controls the biological signal feature information extractor 30 to extract bio-signal feature information about the measured bio-signal.

In step 403, the controller 10 compares the extracted bio-signal feature information with bio-signal feature information stored in the feature information table.

In step 404, the controller 10 determines whether there exists, from bio-signal feature information stored in the feature information table, similar bio-signal feature information to the measured bio-signal feature information. If so, the controller 10 proceeds to step 405. Otherwise, the controller 10 returns to step 401 to control the biological signal measurer 20 to re-measure a bio-signal of the user.

In step 405, the controller 10 detects the similar bio-signal feature information from the feature information table and detects sound source feature information matched to the detected similar bio-signal feature information from the feature information table.

In step 406, the controller 10 determines whether there exists, from sound sources stored in the memory 40, a sound source having similar sound source feature information to the detected sound source feature information. If so, the controller 10 proceeds to step 407. Otherwise, the controller 10 proceeds to step 409.

In step 407, the controller 10 detects the sound source having the similar sound source feature information from the memory 40.

In step 408, the controller 10 updates the detected sound source in a current sound source play list.

The controller 10, which has proceeded to step 409 from step 406 or step 408, determines whether the sound source update has been completed. If not, the controller 10 returns to perform step 401 for bio-signal measurement and then proceeds to subsequent steps 402 to 409.

As is apparent from the foregoing description, a sound source being similar to a user preferred sound source is searched by using a bio-signal of the user, thereby allowing the user to enjoy the sound source being similar to the preferred sound source for each user situation.

Moreover, while the user listens to the music, the bio-signal of the user is measured and bio-signal feature information about the measured bio-signal is matched to sound source feature information in advance, thereby enabling subsequent automatic selection of a user preferred sound source by using the measured bio-signal.

Furthermore, by matching bio-signal feature information to sound source feature information about a sound source selected by the user, it is highly likely that a sound source being similar to a user preferred sound source is found.

While the present invention has been shown and described with reference to an embodiment thereof, it will be understood by those skilled in the art that various changes in form and details may be made therein without departing from the spirit and scope of the invention as defined by the appended claims.

What is claimed is:

1. An apparatus for searching for a sound source, comprising:
a biological signal measurer for measuring a biological signal of a user;
a biological signal feature information extractor for extracting biological signal feature information about the measured biological signal;
a sound source feature information extractor for extracting sound source feature information about a sound source;
a memory for storing a plurality of sound sources; and
a controller for controlling the sound source feature information extractor to extract sound source feature information about a sound source upon user's selection of the sound source, generating a feature information table by matching the biological signal feature information about the measured biological signal to the extracted sound source feature information, controlling the biological signal measurer to measure a biological signal at the request of the user, extracting similar biological signal feature information to that of the measured biological signal from biological signal feature information stored in the feature information table, searching for a sound source having similar sound source feature information matched to the similar biological signal feature information among the plurality of sound sources stored in the memory, and updating the found sound source in a sound source play list.

2. The apparatus of claim 1, wherein the biological signal feature information comprises at least one of feature information associated with a heart rate, feature information resulting from wavelet transform on respective bits of the biological signal, feature information using frequency characteristic values of a Heart Rate Variability (HRV), and a power spectrum value, which is an integral of a Power Spectrum Density (PSD) between a low-frequency band and a high-frequency band determined from a frequency component acquired by Fast Fourier Transform (FFT) with respect to maximum, minimum, mean, and standard deviations of the heart rate, and the HRV.

3. The apparatus of claim 1, wherein the sound source feature information comprises at least one of a pitch change, a duration of a sound source, and a tempo of a sound source.

4. The apparatus of claim 1, wherein when a difference between the extracted biological signal feature information and the stored biological signal feature information is less than a threshold, the stored biological signal feature information is determined as the similar biological signal feature information.

5. The apparatus of claim 1, wherein when a difference between the extracted sound source feature information and the stored sound source feature information about the plurality of sound sources is less than a threshold, the stored sound source feature information is determined as the similar sound source feature information.

6. A method for searching for a sound source, comprising:
extracting sound source feature information about a sound source if the sound source is selected by a user;
measuring a biological signal of the user for each situation of the user;
extracting biological signal feature information about the measured biological signal;
generating a feature information table by matching the extracted biological signal feature information to the extracted sound source feature information;
measuring a biological signal at a request of the user;
detecting similar biological signal feature information to the extracted biological signal feature information from biological signal feature information stored in the feature information table;
searching for a sound source having similar sound source feature information to sound source feature information mapped to the detected similar biological signal feature information from a plurality of sound sources; and
updating the found sound source in a sound source play list.

7. The method of claim 6, wherein the biological signal feature information comprises at least one of feature information associated with a heart rate, feature information resulting from wavelet transform on respective bits of the biological signal, feature information using frequency characteristic values of a Heart Rate Variability (HRV), and a power spectrum value, which is an integral of a Power Spectrum Density (PSD) between a low-frequency band and a high-frequency band determined from a frequency component acquired by Fast Fourier Transform (FFT) with respect to maximum, minimum, mean, and standard deviations of the heart rate, and the HRV.

8. The method of claim 6, wherein the sound source feature information comprises at least one of a pitch change, a duration of a sound source, and a tempo used by a sound source.

9. The method of claim 6, wherein the detecting of the similar biological signal feature information comprises:
calculating a difference between the extracted biological signal feature information and the biological signal feature information stored in the feature information table; and
detecting biological signal feature information corresponding to the calculated difference which is less than less than a threshold.

10. The method of claim 6, wherein the detecting of the similar sound source feature information comprises:
calculating a difference between the extracted sound source feature information and sound source feature information about each of the plurality of sound sources; and
detecting a sound source corresponding to the calculated difference which is less than less than a threshold.
